(19) United States
(12) Patent Application Publication
(10) Pub. No.: US 2024/0266711 A1
(43) Pub. Date: Aug. 8, 2024

(54) ANTENNA MOUNT EXTENSION BRACKET WITH A RETENTION AND ALIGNMENT CLIP

(71) Applicant: Viavi Solutions Inc., Chandler, AZ (US)

(72) Inventor: Adam WOOLSEY, Indianapolis, IN (US)

(73) Assignee: Viavi Solutions Inc., Chandler, AZ (US)

(21) Appl. No.: 18/166,254

(22) Filed: Feb. 8, 2023

(51) Int. Cl. H01Q 1/12; H01Q 1/20; H01Q 3/04

(52) U.S. Cl. CPC H01Q 1/1221; H01Q 1/20; H01Q 3/04

(57) ABSTRACT

A bracket for mounting an antenna to an antenna alignment device may comprise a base bracket and an extension bracket. The extension bracket may comprise a retention clip that may be inserted into a slot in the base bracket. Particularly, the extension bracket with the antenna alignment device may be lifted up with one hand such that the retention clip can be inserted into the slot. The forward weight of the antenna alignment device may pull down the extension bracket to allow the retention clip and the slot to form a retention mechanism. To disengage the retention mechanism, the extension bracket can be pushed forward, then lifted up. Therefore, the combination of the base bracket and the extension bracket may provide a convenient, one-hand installation of an antenna alignment device at different positions at a distance with respect to an external surface of the antenna.

### BACKGROUND

Modern communication systems rely heavily on wireless signals transmitted and received by antennas. On the transmit side, antennas receive fluctuating electrical currents through wires from connected circuitry and generate wireless signals as electromagnetic fields corresponding to the fluctuating electrical currents. On the receive side, antennas convert electromagnetic fields of the received wireless signals to electrical currents carried through wires to the connected circuitry. Because of directional oscillation of electrical and magnetic fields, wireless signaling through the transmittal and receipt of electromagnetic fields is inherently directional: heavily influenced by the location of the signal source, multipathing, beamforming, and or other aspects associated with electromagnetic fields and electromagnetic radiation. Therefore, for an optimal bandwidth and signal strength, antennas—both on the transmit and receive sides—may require precise alignments and tuning with respect to each other.

To achieve such precise alignments and tuning, antenna alignment devices are generally used for measuring and tuning physical antenna attributes such as azimuth, tilt, and or roll. An antenna alignment device is generally an electronic device that is mounted on the antenna or a structure supporting the antenna. Once mounted, the antenna alignment device's electronic and magnetic components measure antenna tuning parameters and or a directional alignment of the antenna in terms of antenna roll, tilt, and or azimuth. Feedback provided by the antenna alignment device, e.g., through an interface, may be used to tune the antenna and or adjust the alignment of the antenna to a desired roll, tilt, and or azimuth.

An antenna alignment device is mounted to the antenna or a structure supporting the antenna by using a mounting bracket. The mounting bracket generally has clamping, fastening and or any type of attachment mechanism for the mounting bracket to the attached to the antenna. The mounting bracket further has other fastening mechanisms such as screws to mount the antenna alignment device to the mounting bracket. Once both the antenna alignment device-to-bracket and the bracket-to-antenna fastening is done, the antenna alignment device may be used for antenna alignment operations.

Conventional mounting brackets, however, have several technical shortcomings. A conventional mounting bracket may have a few positions to attach an antenna alignment device, but these positions are within the body of the mounting bracket do not allow for different positions of the antenna alignment device at a distance from the antenna. The different positions at a distance may desired for antennas that are at inconvenient locations and there may not be enough space for the antenna alignment device to stay physically close to the antenna. Furthermore, there may be multiple antennas at a single location and an antenna alignment device closer to a first antenna may be within a shadow region of a second antenna, thereby failing to provide desired alignment for the first antenna vis-à-vis the second antenna. Additionally, a conventionally mounted antenna alignment device may interfere with the operation of the antenna due to the physical proximity—for example, the electromagnetic fields generated by the internal circuitry of the antenna alignment device may interfere with the electromagnetic fields transmitted/received by the antenna.

Conventional mounting brackets are also inconvenient for a mounting operation itself. These mounting brackets generally require a technician to use both hands to place an antenna alignment device at a desired position and screw it in place. Using both hands is generally inconvenient and even dangerous when the antenna alignment is being performed at considerable heights, e.g., at the top of an antenna tower.

As such, a significant improvement in mounting brackets for antenna alignment devices is therefore desired.

### SUMMARY

Embodiments disclosed herein attempt to solve the aforementioned technical problems and may provide other solutions as well. In an example embodiment, a bracket for mounting an antenna to an antenna alignment device may comprise a base bracket and an extension bracket. The extension bracket may comprise a retention clip that may be inserted, then pulled back into the slot on the base bracket. Particularly, the extension bracket with the antenna alignment device may be lifted up with one hand such that the retention clip can be inserted into the slot, then pulled back. The weight of the antenna alignment device may pull down the extension bracket to allow the retention clip and the slot to form a retention mechanism. To disengage the retention mechanism, the extension bracket can be pushed forward, then lifted up. Therefore, the combination of the base bracket and the extension bracket may provide a convenient, one-hand installation of an antenna alignment device at different positions at a distance with respect to an external surface of the antenna.

In an embodiment, a mounting bracket for mounting an antenna alignment device to an antenna may be provided. The mounting bracket may comprise a base bracket configured to be attached to an external surface of an antenna, the base bracket comprising a slot. The mounting bracket may further comprise an extension bracket configured to be attached to an antenna alignment device, the extension bracket comprising a retention clip configured to be inserted into the slot, the retention clip and the slot forming a retention mechanism that engages using the forward weight of the antenna alignment device.

In another embodiment, a method of mounting an antenna alignment device to an antenna is provide. The method may comprise attaching a base bracket to an external surface of an antenna, the base bracket comprising a slot. The method may also comprise attaching an extension bracket an antenna alignment device, the extension bracket comprising a retention clip. The method may further comprise inserting the retention clip into the slot such that the retention clip and the slot form a retention mechanism that engages using a weight of the antenna alignment device.

It should be understood that this summary just provides example embodiments for a quick introduction of the disclosure and therefore should not be considered limiting.

### BRIEF DESCRIPTION OF THE DRAWINGS

FIG. 1 shows a perspective view an example environment for antenna alignment, based on the principles disclosed herein.

FIG. 2A shows a side view of the antenna alignment environment when an extension bracket is in a raised position, based on the principles disclosed herein.

FIG. 2B shows a side view of the antenna alignment environment where the extension bracket is in an engaged (i.e., non-raised) position with a base bracket.

FIG. 3A shows a side section-view of a portion of the antenna alignment environment, based on the principles disclosed herein.

FIG. 3B shows a side section-view of a portion of the antenna alignment environment, based on the principles disclosed herein.

FIG. 3C shows a side section-view of a portion of the antenna alignment environment, based on the principles disclosed herein.

FIG. 4 shows a side view of the extension bracket shown in FIGS. 1-3C, based on the principles disclosed herein.

FIG. 5 shows a perspective view of a portion of the extension bracket, based on the principles disclosed herein.

FIG. 6 shows a perspective view of a retention clip, based on the principles disclosed herein.

FIG. 7 shows a top view of the base bracket, based on the principles disclosed herein.

FIG. 8 shows a flow diagram of an example method of mounting an antenna alignment device to an antenna, based on the principles disclosed herein.

It should be understood that the drawings are just for illustrating the principles disclosed herein and therefore should not be considered limiting.

### DETAILED DESCRIPTION OF SEVERAL EMBODIMENTS

Conventional brackets for mounting an antenna alignment device to an antenna have several technical shortcomings. They provide limited positions for the antenna alignment device in close physical proximity to the antenna and require an inconvenient two-hand installation. Embodiments disclosed herein solve these problems by providing an extension bracket and a base bracket with a retention mechanism the engages due to the forward weight of the antenna alignment device. Particularly, the extension bracket includes a retention clip that may be inserted into the slot, then pulled back on the base bracket when the extension bracket is tilted/raised. Once the extension bracket is let go, the forward weight of the antenna alignment device pulls down on the extension bracket thereby engaging the retention mechanism formed by the retention clip and the slot. Furthermore, the retention clip may be horizontally moved within the slot.

The extension bracket therefore provides several different positions for mounting an antenna alignment device at a distance from the antenna. Such mounting minimizes interference from the antenna alignment device to an antenna and also may provide more optical alignment locations when multiple antennas may have to be aligned. Furthermore, the retention mechanism enabled by just the weight of the antenna alignment device may provide for a convenient, one-hand installation. The technician does not have to hold on the extension bracket when the extension bracket is being attached. The technician can just insert the retention clip while maintaining the tilt of the extension bracket using one hand, let gravity engage the retention clip with the slot in the base bracket, and then proceed on to screw the extension bracket to the base bracket.

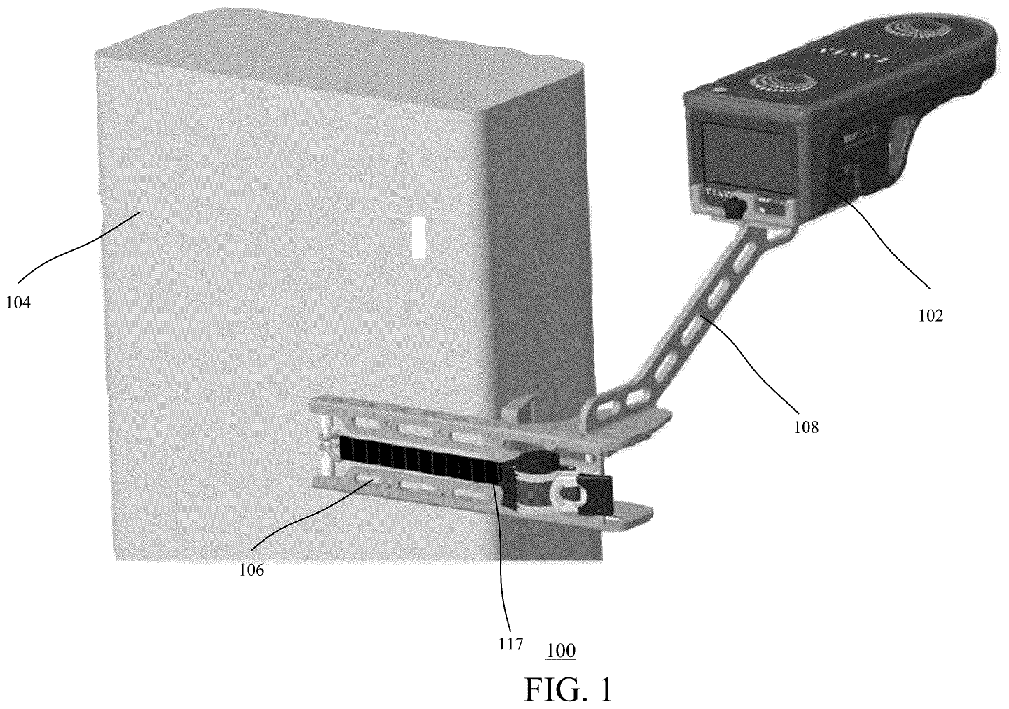

FIG. 1 shows a perspective view an example environment 100 for antenna alignment, based on the principles disclosed herein. The example environment 100 includes an antenna 104, which may be disposed on a support structure (not shown). The support structure may include structures such as an antenna tower, rooftop, treetop, building wall, vehicle top, satellite, and or the like. Furthermore, the antenna 104 can be any type of antenna, including a dome antenna, a sector antenna, a microwave antenna, an omnidirectional antenna, a loop antenna, a multibeam antenna, a Yagi-type antenna, and/or any type of antenna that may have to be aligned for optimal performance. In some embodiments, the antenna 104 may be a part of a cellular telephony network such as 5^{th} generation mobile network (5G).

An antenna alignment device 102 may be used for aligning the antenna 104. For example, the antenna alignment device 102 may output alignment information such as roll, tilt, and/or azimuth. Using the alignment information, a user may adjust the antenna 104 such that it a desired roll, tilt, and or azimuth. For example, the antenna alignment device 102 may provide measured antenna alignment parameters, which may then be analyzed to determine whether the antenna 104 has the desired alignment. As used herein antenna alignment parameters may include parameters such as roll, tilt, and or azimuth and or any type of antenna tuning parameters.

As shown, the antenna alignment device 102 may be mounted to the antenna 104 using a base bracket 106 and an extension bracket 108. The base bracket 106 may include any type of bracket or attachment mechanism (as shown, a ratchet and a strap mechanism 117) that attaches to an external surface of the antenna. The extension bracket 108 may attach to the base bracket 106 at one end and receive the antenna alignment device 102 at another end. The extension bracket 108 may therefore provide different positions for the antenna alignment device 102 vis-à-vis the external surface of the antenna. In other words, unlike the conventional brackets that just attach antenna alignment devices very close to corresponding antennas, embodiments disclosed herein provide a more convenient location for the antenna alignment device 102 to be mounted on.

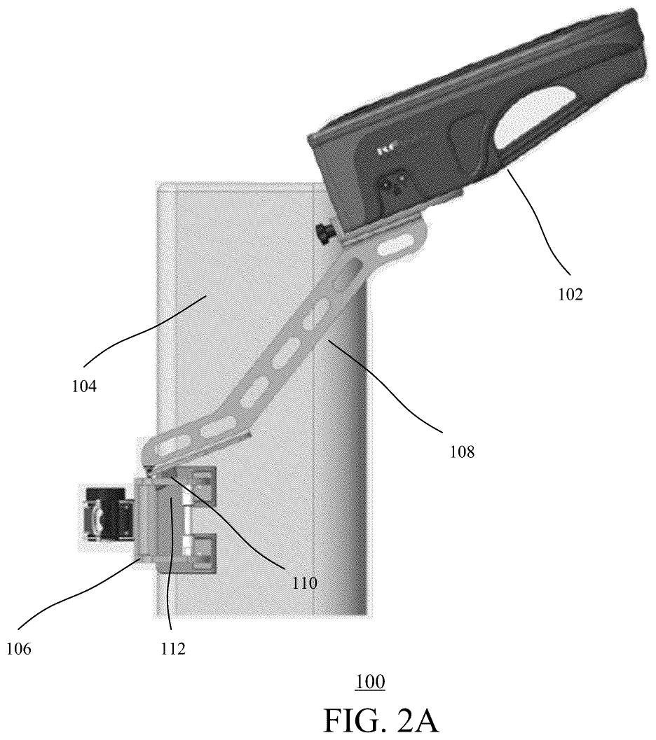

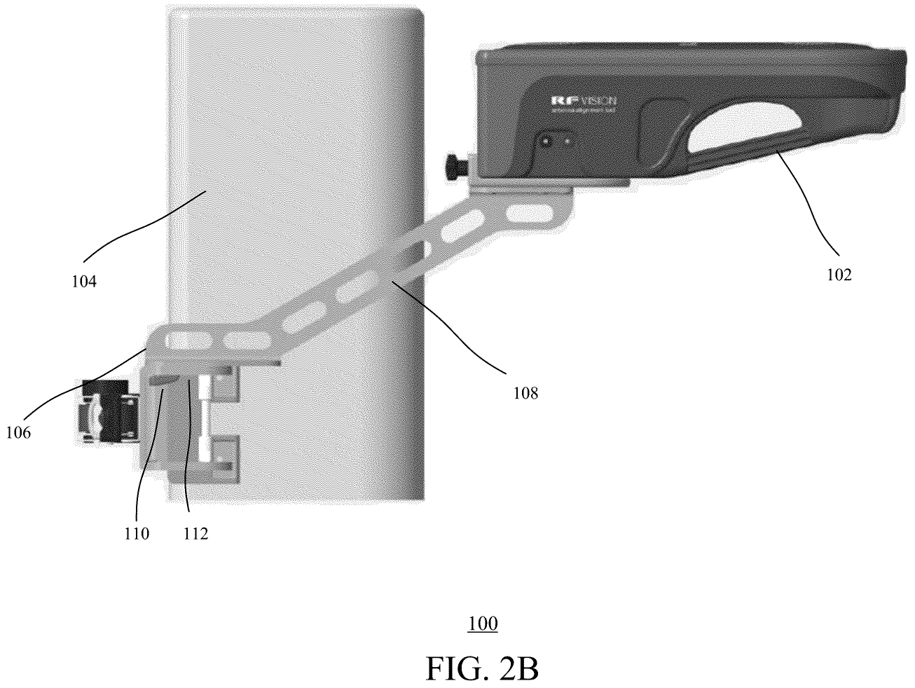

FIG. 2A shows a side view of the antenna alignment environment 100 when the extension bracket 108 is in a raised (also referred to as tilted) position, based on the principles disclosed herein. The extension bracket 108 may be raised at an initial step of mounting when the extension bracket 108 is being attached to the base bracket 106. The attachment between the extension bracket 108 and the base bracket 106 and the relative orientation (e.g., the shown raised position) may be facilitated by a retention clip 110 on the extension bracket 108 and a slot 112 on the base bracket 106. That is, the retention clip 110 may be adjustably inserted into the slot 112. Particularly retention clip 110 may be able to tilt, horizontally slide, and or engage one or more sides of the slot 112.

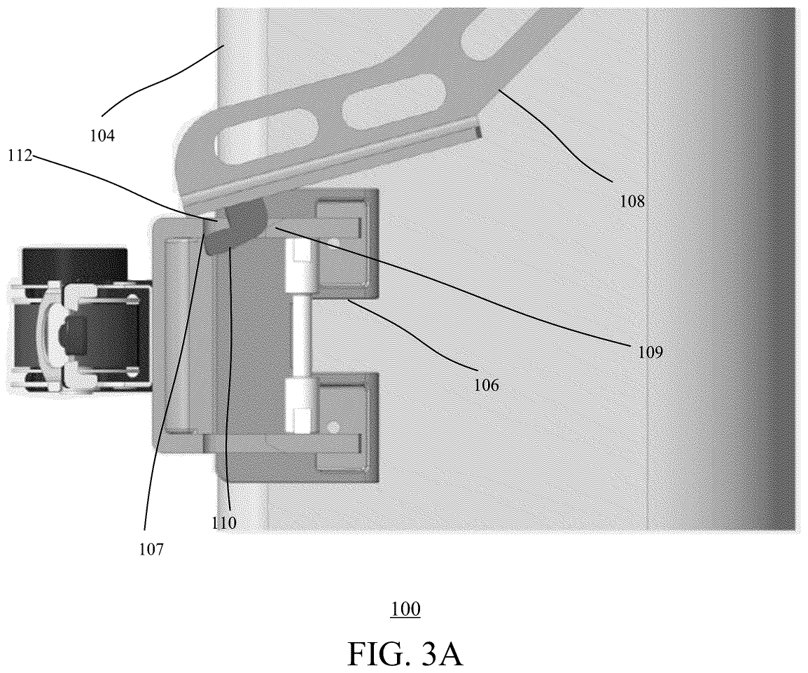

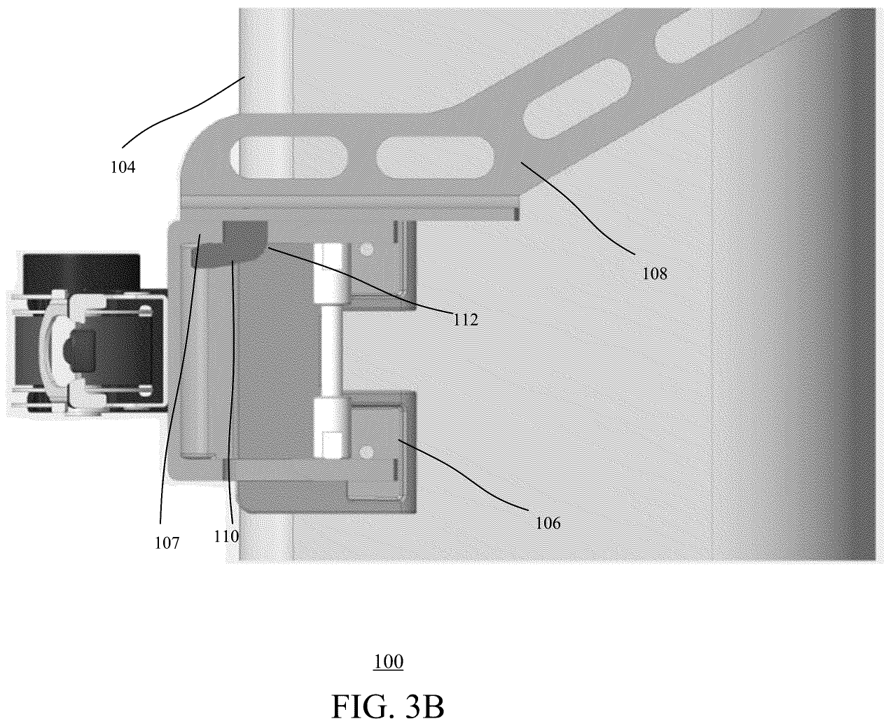

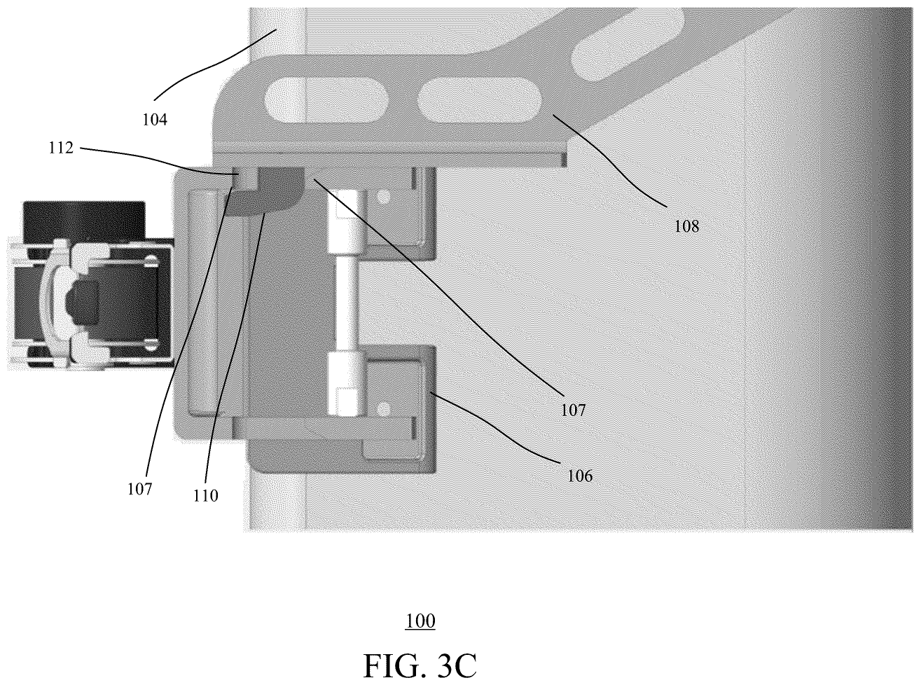

FIG. 2B shows a side view of the antenna alignment environment 100 where the extension bracket 108 is in an engaged (i.e., non-raised) position with the base bracket 106. In the engage position, the retention clip 110 engages with a side (shown in FIGS. 3A and 3B below) of the slot 112 and the forward weight of the antenna alignment device 102 facilitates such engagement. Therefore, the retention clip 110 and the slot 112 form a retention mechanism that uses the weight (i.e., gravitational pull) of the antenna alignment device 102.

During an installation, a technician may first fasten the base bracket 106 to the antenna 104. Then the antenna alignment device 102 may be attached to the extension bracket 108. The technician can then use one hand to insert the retention clip 110 to the slot 112 with the extension bracket 108 in a raised position (as shown in FIG. 2A). When the technician lets go of the extension bracket 108 and the antenna alignment device 102 combination, the forward weight of the antenna alignment device 102 pulls down the extension bracket 108 thereby engaging the retention clip 110 to the slot 112. At this point, the technician does not have to physically hold any portion of the base bracket 106 and the extension bracket 108. Once the technician is satisfied with the position of the antenna alignment device 102, the technician may fasten (e.g., by using screws) the extension bracket 108 to the base bracket 106. Therefore, the use of the retention mechanism formed by the retention clip 110 and the slot 112 may facilitate a convenient, one-hand mounting of the antenna alignment device 102 to the antenna 104 for aligning the antenna 104.

FIG. 3A shows a side section-view of a portion of the antenna alignment environment 100, based on the principles disclosed herein. Particularly, FIG. 3A shows a situation when the extension bracket 108 is in a raised position. As shown, the retention clip 110 is in a tilted position with respect to the slot 112. As described above, this raised position may be at the initial steps of mounting the antenna alignment device 102 to the antenna 104. Using one hand, the technician inserts the retention clip 110 to the slot 112 while maintaining the shown tilt. A front side 109 of the slot may have an oblique or slanted configuration to facilitate such tilted insertion.

FIG. 3B shows a side section-view of a portion of the antenna alignment environment 100, based on the principles disclosed herein. Particularly, FIG. 3A shows another situation when the extension bracket 108 is in an engaged (non-raised) position. In this position, the retention clip 110 may engage with a back side 107 of the slot 112. This engagement may not require the technician to continue holding on the extension bracket 108—the technician may simply let go of the extension bracket 108 (with the antenna alignment device 102), and the forward weight of the antenna alignment device 102 pulls down on the extension bracket 108 to engage the retention clip 110 with the back side 107 of the slot 112. Therefore, the retention clip 110 and slot 112 form a retention mechanism that uses the weight of the antenna alignment device 102. The retention mechanism may be disengaged when the technician again raises the extension bracket 108 as shown in FIG. 3A.

FIG. 3C shows a side section-view of a portion of the antenna alignment environment 100, based on the principles disclosed herein. Particularly, FIG. 3C shows yet another situation when the extension bracket 108 is in an engaged (non-raised) position. In contrast to FIG. 3B where the retention clip 110 was all the way at the back of the slot 112, the retention clip 110 in FIG. 3C is toward the front of the slot 112, while still engaging with the back side 107 of the slot 112. Therefore, the retention clip 110 may be engaged to the slot 112 at any horizontal position thereby allowing another degree of flexibility in positioning the antenna alignment device 102 with respect to the antenna 104. The extension bracket 108 may then be locked (e.g., by using screws) at any of the horizontal positions.

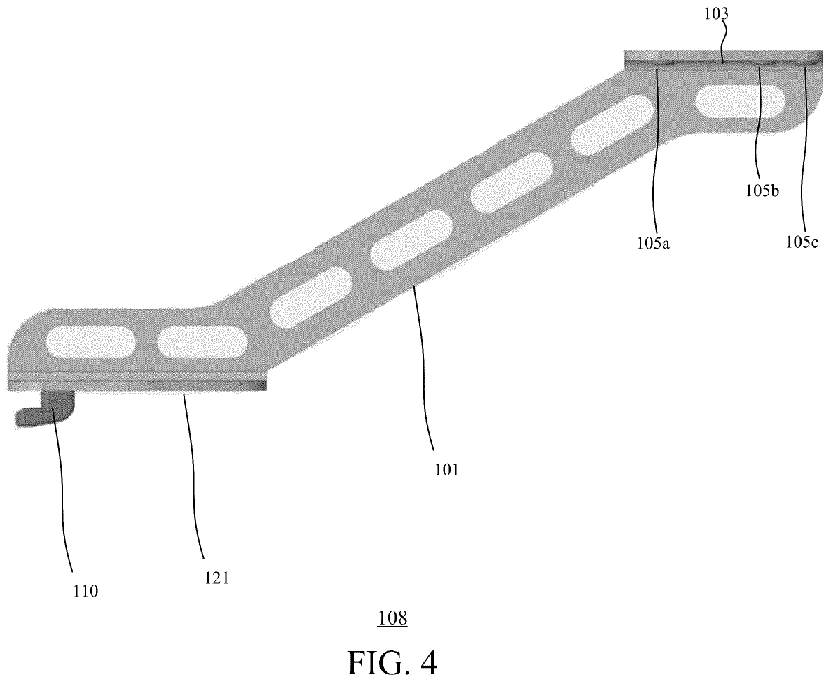

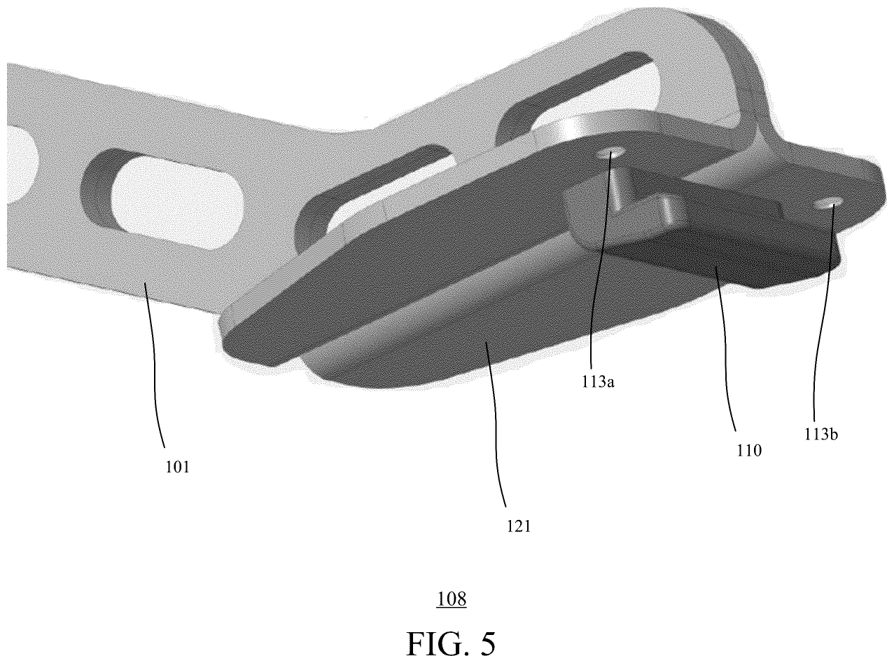

FIG. 4 shows a side view of the extension bracket 108 shown in FIGS. 1-3C, based on the principles disclosed herein. As shown, the extension bracket 108 may include a body 101 that may be formed using aluminum. The shape and size of the body 101 may provide the actual extension of the position of the antenna alignment device 102 with respect to the antenna 104. A first platform 103 may allow for attaching the antenna alignment device 102 to the extension bracket 108. Once the antenna alignment device 102 is on the first platform 103, one or more screws (to engage the example screw holes shown as 105a, 105b, 105c) to secure the antenna alignment device 102 to the extension bracket 108. A second platform 121 may be used to attach the extension bracket 108 to the base bracket 106. The second platform 121 may also have screw holes (described in FIG. 5 below) used to receive screws to secure (or lock) the extension bracket 108 to the base bracket 106. The retention clip 110 may be attached to the lower side of the second platform 121.

FIG. 5 shows a perspective view of a portion of the extension bracket 108, based on the principles disclosed herein. The perspective view shows the bottom surface of the second platform 121 where the retention clip 110 is attached. Furthermore, screw holes 113a, 113b are provided to secure the second platform 121 to the base bracket 106.

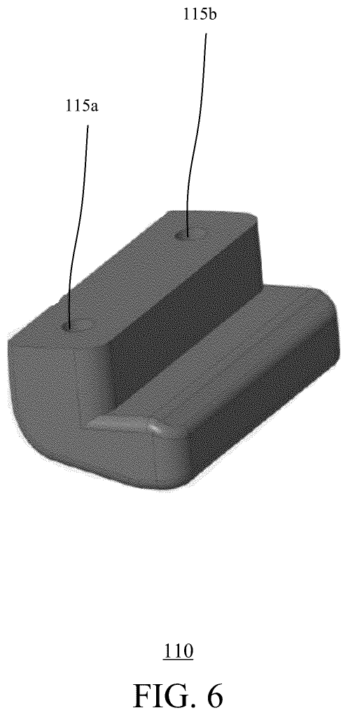

FIG. 6 shows a perspective view of the retention clip 110, based on the principles disclosed herein. The retention clip 110 may be attached to the second platform 121 through screws on the screw holes 115a, 115b. However, any kind of attachment mechanism should be considered within the scope of this disclosure. Alternatively, the retention clip 110 may be integrally formed with the second platform 121. The retention clip 110 may be made of any material such as aluminum.

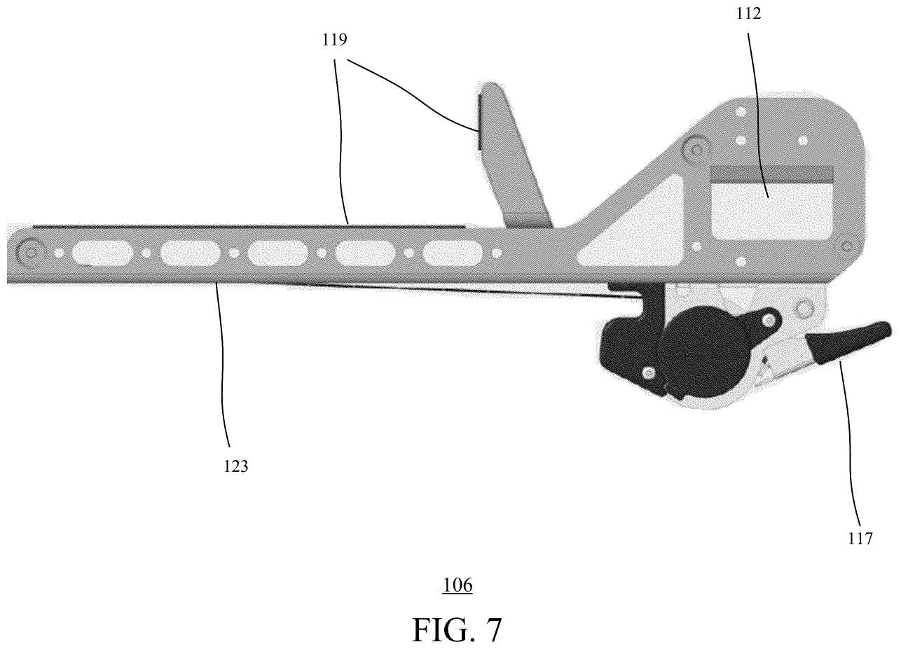

FIG. 7 shows a top view of the base bracket 106, based on the principles disclosed herein. The base bracket 106 may include a main body 123, which may be made of aluminum. A fastening mechanism 117 (e.g., a ratchet strap) may be used to fasten the base bracket 106 to the antenna 104. Furthermore, the base bracket 106 may have attachment surfaces 119 that abut the antenna 104 when the base bracket 106 is fastened to the antenna 104. As described above, the base bracket 106 may include the slot 112 that forms a retention mechanism along with the retention clip 110.

FIG. 8 shows a flow diagram of an example method 800 of mounting an antenna alignment device to an antenna, based on the principles disclosed herein. It should be understood that the steps of the method 800 are just shown as examples and methods with additional, alternative, or fewer number of steps should be considered within the scope of this disclosure. Furthermore, the shown sequence of steps is just for illustration and should not be considered limiting.

At step 802, a base bracket may be attached to the antenna. The base bracket may be attached using any kind of attachment mechanism such as ratcheting, clamping, etc. At step 804, the antenna alignment device may be attached to an extension bracket. The antenna alignment device may be attached using any kind of mechanism such as screws, etc.

At step 806, the extension bracket may be inserted in a raised position to the base bracket. The insertion may be one-handed—a technician can simply use one and hand to insert a retention clip of the extension bracket into a slot of the base bracket while maintaining the tilt of the extension bracket. At step 808, the retention clip of the extension bracket may engage the slot bracket because of the weight of the antenna alignment device. That is, when the technician lets go of the extension bracket it remains attached to the base bracket as the retention clip engages a back wall of the slot due to the gravitational pull on the antenna alignment device.

At step 810, a horizontal position of the retention clip within the slot may be adjusted. The adjustment may be made by laterally moving the extension bracket while the retention clip still maintains the engagement with the slot. After a desired position of the antenna alignment device is reached, the extension bracket may be secured to the base bracket in step 812. The securing may be done by using screws, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A mounting bracket for mounting an antenna alignment device to an antenna, the mounting bracket comprising:
a base bracket configured to be attached to an external surface of an antenna, the base bracket comprising a slot; and
an extension bracket configured to be attached to an antenna alignment device, the extension bracket comprising a retention clip configured to be inserted into the slot, the retention clip and the slot forming a retention mechanism that engages using a forward weight of the antenna alignment device.

2. The mounting bracket of claim 1, wherein the retention mechanism is configured to be released when the extension bracket is pushed forward, then raised.

3. The mounting bracket of claim 1, wherein the retention clip is configured to slide to different positions within the slot.

4. The mounting bracket of claim 3, wherein the extension bracket is configured to be locked to the base bracket at each of the different positions of the retention clip within the slot.

5. The mounting bracket of claim 1, wherein the extension bracket is configured to be mounted to the base bracket through a one hand operation.

6. The mounting bracket of claim 1, wherein each of the base bracket and the extension bracket is made of aluminum.

7. The mounting bracket of claim 1, wherein the retention clip is configured to engage a back side of the slot.

8. The mounting bracket of claim 1, wherein the slot has an oblique front side configured to facilitate an insertion of the retention clip into the slot when the extension bracket is raised.

9. The mounting bracket of claim 1, wherein the retention clip is formed integrally with the extension bracket.

10. The mounting bracket of claim 1, wherein the retention clip is attached to the extension bracket.

11. A method of mounting an antenna alignment device to an antenna, the method comprising:
attaching a base bracket to an external surface of an antenna, the base bracket comprising a slot;
attaching an extension bracket an antenna alignment device, the extension bracket comprising a retention clip; and
inserting the retention clip into the slot such that the retention clip and the slot form a retention mechanism that engages using a forward weight of the antenna alignment device.

12. The method of claim 11, further comprising:
releasing the retention mechanism by pushing forward, then raising the extension bracket.

13. The method of claim 11, further comprising:
sliding the retention clip to different positions within the slot.

14. The method of claim 13, further comprising:
locking the extension bracket to the base bracket at one position of the different positions of the retention clip within the slot.

15. The method of claim 11, further comprising:
mounting the extension bracket is configured to the base bracket through a one hand operation.

16. The method of claim 11, wherein each of the base bracket and the extension bracket is made of aluminum.

17. The method of claim 11, further comprising:
engaging, by the retention clip, a back side of the slot.

18. The method of claim 11, further comprising:
facilitating, by an oblique front side of the slot, an insertion of the retention clip into the slot when the extension bracket is raised.

19. The method of clai 11, wherein the retention clip is formed integrally with the extension bracket.

20. The method of claim 11, wherein the retention clip is attached to the extension bracket.
